(19) United States
(12) Patent Application Publication
(10) Pub. No.: US 2008/0209227 A1
(43) Pub. Date: Aug. 28, 2008

(54) User Authentication Via Biometric Hashing

(75) Inventors: Ramarathnam Venkatesan, Redmond, WA (US); Mariusz H. Jakubowski, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/680,433

(22) Filed: Feb. 28, 2007

(51) Int. Cl. H04L 9/00

(52) U.S. Cl. 713/186

(57) ABSTRACT

Techniques for authenticating biometric parameters via biometric hashing are described. In one implementation, a biometric parameter of a user (e.g., fingerprint image, blood-vessel pattern, retina scan, etc.) is captured. One or more biometric hashes are produced from the biometric parameter. To generate hashes that appear random, pseudorandom metrics are applied over the biometric parameter. The hashes are stored in association with user information that can be employed to authenticate the user. Subsequently, during authentication, a new biometric parameter is captured and hashes are computed from the parameter. The new biometric hashes are then compared with the predetermined stored hashes. If any of the new hashes are found to be identical, or sufficiently similar, to one or more of the predetermined biometric hashes, the biometric parameter is deemed valid and the user is authenticated.

### BACKGROUND

Currently, user authentication technology is used in variety of popular scenarios, such as system logons, building security access, web-based authentication, and so on. In a generic biometric system, physical and behavioral characteristics of humans are registered. This information is then processed by a predefined algorithm, converted into digital data, and the results are maintained in a database. During a subsequent user authentication session, a biometric parameter of the user is captured again and processed. The newly obtained results are compared with those existing in the database to determine whether there is match. This process is repeated for each user authentication session. Unfortunately, such generic biometric systems commonly experience time delays due to the tedious processing of biometric parameters.

Accordingly, there remains a need to improve biometric based authentication technology.

### SUMMARY

Techniques for authenticating biometric parameters via biometric hashing are described. In one implementation, a biometric parameter of a user (e.g., fingerprint image, blood-vessel pattern, retina scan, etc.) is captured. One or more biometric hashes are produced from the biometric parameter. To generate hashes that appear random, pseudorandom (e.g., key-derived) metrics are applied over the captured biometric parameter. The hashes are stored in association with user information that can be employed to authenticate the user. Subsequently, during authentication, a new biometric parameter is captured and hashes are computed from the parameter. The new biometric hashes are then compared with the predetermined stored hashes. If any of the new hashes are found to be identical, or sufficiently similar, to one or more of the predetermined biometric hashes, the biometric parameter is deemed valid and the user is authenticated. In other implementations, for enhanced security, multiple biometric parameters of the user may be evaluated as a group, or one or more biometric parameters may be evaluated together with a user-supplied password.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left most digit(s) of a reference number identifies the figure in which the reference number first appears. The same numbers are used throughout the drawings to reference like features and components:

FIG. 1 is a block diagram with selected components in an exemplary system for creating biometric hashes from biometric parameters and using the hashes to authenticate users.

FIG. 2 is a block diagram of an exemplary hash generation module from the system of FIG. 1. The hash generation module is configured to generate one or more biometric hashes from a biometric parameter.

FIG. 3 illustrates an exemplary technique of generating one or more biometric hashes from an image of a user's fingerprint.

FIG. 4 illustrates an exemplary hash verification module from the system of FIG. 1. The hash verification module is configured to authenticate biometric parameters through analysis of the biometric hashes.

FIG. 5 illustrates an exemplary network system in which biometric authentication is implemented to facilitate client access to resources over a network.

FIG. 6 is a flow diagram showing an exemplary process for creating hashes of biometric parameters and subsequently using the hashes to authenticate the biometric parameters of users.

FIG. 7 is a flow diagram illustrating an exemplary process for validating biometric parameters using a distance analysis on the biometric hashes.

FIG. 8 is a flow diagram showing an exemplary process for using biometric hashes derived from multiple biometric parameters, optionally along with a user-supplied password, to authenticate a user.

### DETAILED DESCRIPTION

The disclosure is directed to techniques for authenticating biometric parameters using biometric hashing. Biometric parameters (e.g., fingerprint, retina scan, etc.) may be used in any number of user authentication scenarios, such as system logons, building access, and web-based authentication. Generally, biometric hashes are computed from one or more biometric parameters of a user. To generate hashes that appear random, a number of pseudorandom metrics are applied over the biometric parameters. Various types of metrics may be customized for associated biometric parameters. Thus, metrics applied to fingerprints might differ from those applied to retina scans. In the case of fingerprints, for example, the metric might be a set of lines or curves randomly crisscrossing an image of the fingerprint. A secret key may be used to determine which metric type to apply and to introduce randomness to the pattern of metrics. To illustrate an example metric, the biometric hashes might be represented by vectors of numbers of the intersections between the lines or curves and features of the fingerprint image. Once computed, the hashes are stored in association with information used to verify or authenticate the user.

When authentication is desired, one or more new biometric parameters are collected from the user and hashes are computed from these new biometric parameters. The new biometric hashes are compared with the predetermined biometric hashes that were previously computed and stored. If one or more new biometric hashes are deemed identical, or sufficiently similar, to the set of predetermined biometric hashes, the user is authenticated.

The techniques described herein may be used in many different operating environments and systems. Multiple and varied implementations are described below. An exemplary environment that is suitable for practicing various implementations is discussed in the following section.

Exemplary System

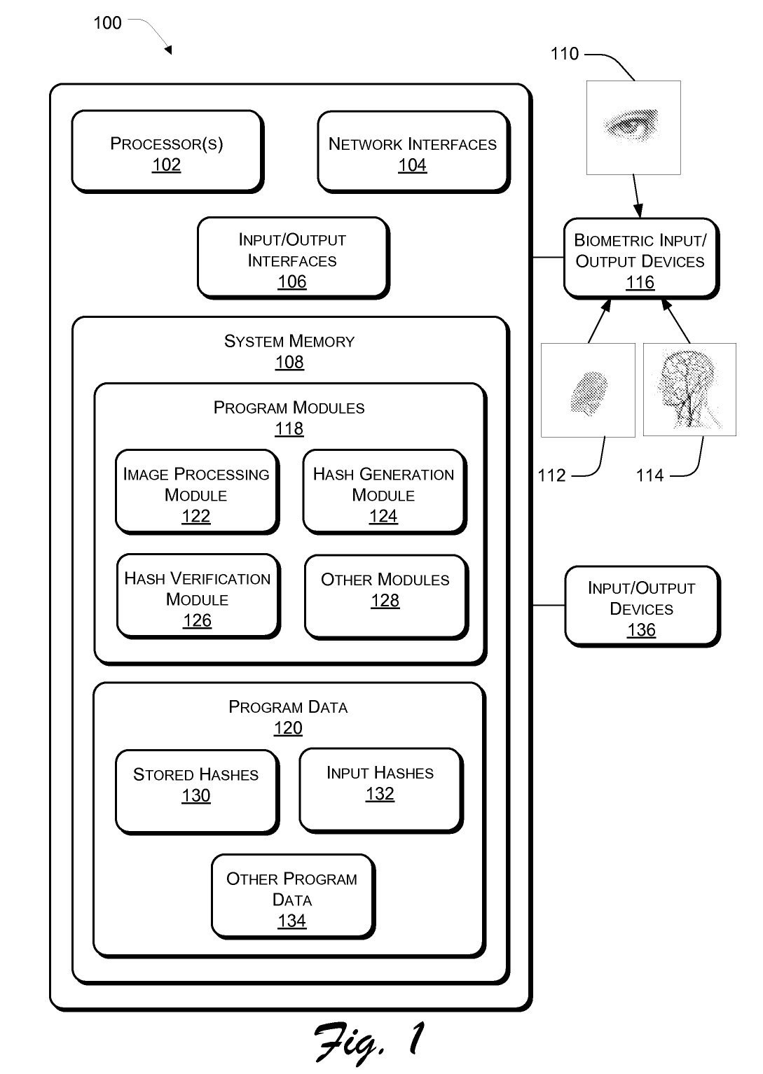

FIG. 1 shows an exemplary system 100 that is configured to implement biometric-based user authentication for any number of applications and scenarios. System 100 may be implemented in many different ways including, for example, a general purpose computing device, a server, a laptop, a mobile computing device, and/or so on. System 100 includes one or more processor(s) 102, network interfaces 104, input/output (I/O) interfaces 106, and system memory 108. Processor(s) 102 may be one or more microprocessors, microcomputers, microcontrollers, dual core processors, and so forth. Network interfaces 104 provide connectivity to a wide variety of networks and protocol types, including wire networks (e.g., LAN, cable, etc.) and wireless networks (e.g., WLAN, cellular, satellite, etc.). I/O interfaces 106 provide data I/O capabilities for system 100 and may include any number of components, such as a scanner port, a mouse port, a keyboard port, and so forth.

System 100 receives data representing a biometric parameter of a user through input/output interfaces 106. The biometric parameter may include characteristics of a human eye 110, a fingerprint 112, blood-vessel patterns 114 (i.e., blood flow can be used to determine a unique look of the veins), and so on. Biometric input/output devices 116 may be employed to capture digital representations of these biometric parameters, such as a retina scan of eye 110, an image scan of fingerprint 112, and patterns of veins 114. Accordingly, examples of biometric I/O devices 116 include a retinal scanner, a fingerprint scanner, a vein scanner, a face reader, and so on. The captured parameters are supplied to system 100 via I/O interfaces 106.

System memory 108 is representative of various memory types used by system 100. System memory 108 includes, for example, volatile random access memory (e.g., RAM) and non-volatile read-only memory (e.g., ROM, flash memory, etc.). System memory 108 is used to store one or more program modules 118 and program data 120. Program modules 118 generally include routines, programs, objects, components, data structures, etc., that perform particular tasks or implement particular abstract data types. In the illustrated implementation, program modules 118 include an image processing module 122, a hash generation module 124, a hash verification module 126, and other modules 128 such as an Operating System (OS) to provide a runtime environment, networked communications between multiple users, and so forth.

As noted earlier, system 100 may be employed for capturing and storing biometric parameters as well as for subsequently authenticating biometric parameters of the user. The different phases or modes of operation (i.e., a registration mode and an authentication mode) may be selected, for example, in response to user input through I/O interfaces 106. In the following discussion, components of system 100 that are used to capture and store the biometric parameters are described first, followed by an explanation of components involved in authenticating biometric parameters.

When an image is initially captured from a biometric parameter, image processing module 122 processes the image to identify the type of biometric parameter (e.g., fingerprints, retinas, blood vessel patterns, etc.). Suppose, for example, that a user wants to store an image of her fingerprint 112 for purposes of authentication. In such a case, the user sets the computing device to a registration mode and scans her fingerprint 112 using a fingerprint scanner (i.e., biometric input/output devices 116). Image processing module 122 receives the fingerprint image and recognizes that the image is associated with a fingerprint.

In one exemplary implementation, image processing module 122 processes the image into a canonical form (i.e., a simplest form of image without losing any significant data) employing one or more filters, such as low-pass filters, median filters, and so on. Further, image processing module 122 may employ various techniques to remove any noisy color or gray scale of the image, thereby leaving a clean two-tone image. It may be noted that image processing module 122 may employ other known techniques for processing the image to reduce noises and distortions.

As part of the processing, image processing module 122 may identify properties associated with the image of the biometric parameter. The properties may include resolution, size, clarity, etc. The properties may determine the amount information pertaining to the biometric parameter that is present in the image. For example, information pertaining to a user's fingerprint may include clarity of the fingerprint impression, number of curves in the captured fingerprint image, and so forth.

In yet another possible implementation, image processing module 122 may review the fingerprint image and deny it if the properties of the image are found unsatisfactory. For example, the properties may be of low quality, such as exhibiting low clarity and too few curves in the fingerprint image. In such a scenario, image processing module 122 may send a request asking the user to reenter a new image of the fingerprint 112.

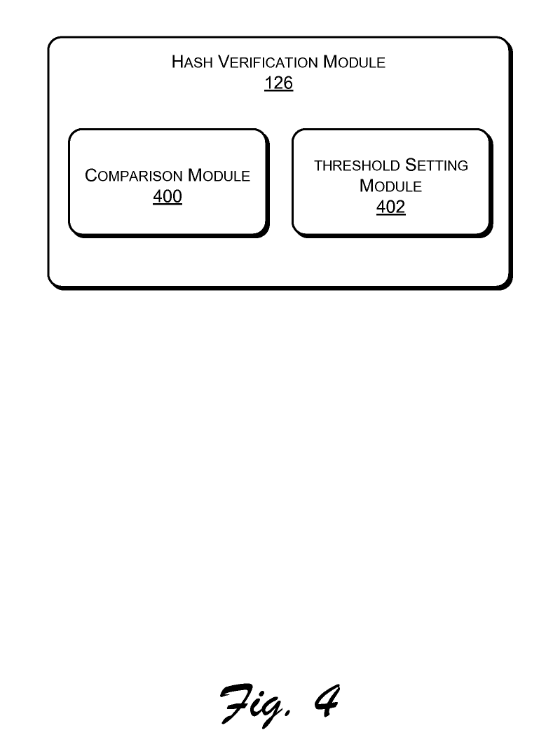

After image processing, hash generation module 124 generates one or more biometric hashes representing the biometric parameter. Hash generation module 124 generates hashes that appear random by applying one or more pseudorandom metrics to the biometric parameter and evaluating the count of significant details of the biometric parameter that may be covered by the metrics. Examples of such metrics can include, for example, lines, curves, circles, rectangles, squares, parallelograms, ellipses, parabolas, any other polygons, and so on. Various types of metrics may be customized for particular human features. One particular example involving line metrics applied to a fingerprint image is described below in more detail with reference to FIG. 3. Other metrics may apply in the case of blood-vessel patterns in human retinas or on human hands. The techniques are not dependent on any particular human feature, but rather metrics can be adapted or devised to produce good results for any given human characteristics.

More particularly, hash generation module 124 embeds a certain number of metrics on the fingerprint image based on the properties. In certain scenarios, hash generation module 124 seeks to apply a maximum number of metrics on the image to extract the utmost amount of information of fingerprint 112. Application of the metrics essentially performs a one-way compression of the fingerprint image into a short vector of pseudorandom numbers. Each element of this vector may be a specially chosen metric evaluated over the canonical fingerprint image. A secret key provides the randomness used for determining metric types and their parameters. The secret keys are stored as other program data 130 in program data 120. The biometric hashes are stored in system memory 108 as stored hashes 130 and saved for later use during authentication.

System 100 may capture multiple biometric parameters and generate different sets of biometric hashes from the parameters. For example, system 100 may capture a combination of different fingerprints, retina scans, blood vessel patterns, and so forth. System 100 may further invite the user to enter a password. This password may be used as another piece of data to authenticate the user, or it may be used as a seed or secret key for hash generation module 124 when producing the biometric hashes. User authentication may then be based on multiple pieces of information, such as multiple biometric hashes from different parameters and/or user entered passwords.

After biometric parameters have been digitally captured and stored, system 100 can be transitioned to an authentication mode to evaluate future biometric parameters for purposes of authentication. When a user seeks authentication, she reenters the biometric parameter. Such parameters are once again captured using biometric I/O devices 116 and passed to I/O interfaces 106 for processing. Image processing module 122 may examine the image to ensure that it is of sufficient quality.

Hash generation module 124 may then compute one or more input hashes from the biometric parameters. These hashes are derived in the same manner as the previously computed hashes. These newly derived hashes may be temporarily stored in program data 120 as input hashes 132.

Hash verification module 126 receives input hashes 132 from hash generation module 124 and analyzes them in relation to stored hashes 130. Ideally, the hashes of the same biometric parameter would be identical. However, in practice, they may not be identical. Thus, in one implementation, hash verification module 126 seeks to determine whether there is sufficient similarity between input hashes 132 and stored hashes 130 to warrant a conclusion that they were derived from the same biometric parameter. Depending upon this measure of similarity, hash verification module 126 may validate or deny the biometric parameter of the user. For example, hash verification module 126 may validate the biometric parameter if the degree of similarity exceeds a threshold value or alternatively declare the biometric parameter as invalid if the degree of similarity fails to exceed this threshold value. Any number of functions or activities may be permitted or denied depending upon this authentication, such as logon procedures, access to resources, physical entrance, and so forth.

System 100 may further include I/O devices 136 to facilitate user input and data output. Such devices include keyboards, mice, displays, printers, speakers, and the like. The user may employ I/O devices 136 to choose the various modes of operation, including the registration mode and authentication mode.

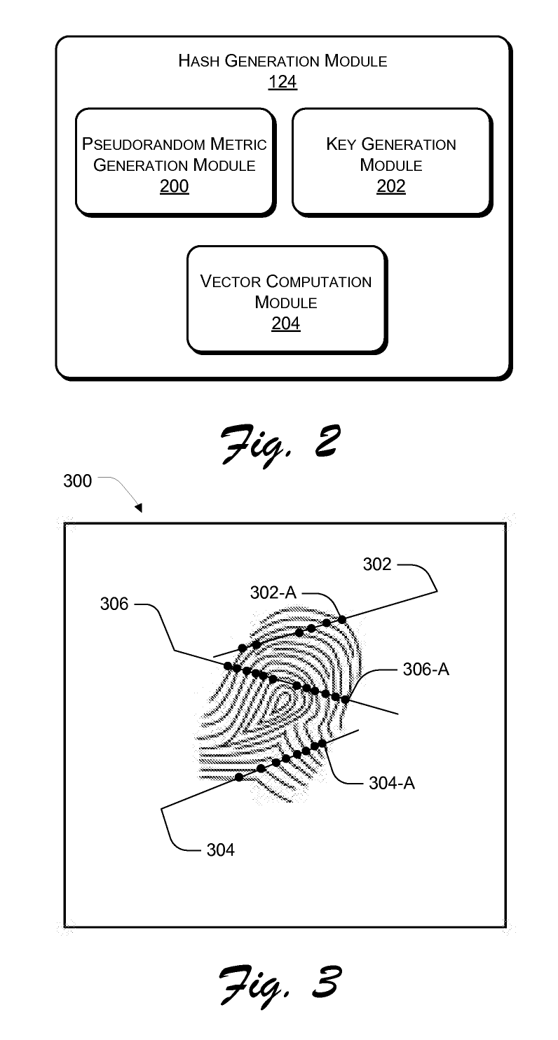

FIG. 2 shows one exemplary implementation of hash generation module 124 in more detail. In this implementation, hash generation module 124 includes a pseudorandom metric generation module 200, a key generation module 202, and a vector computation module 204.

As noted above, hash generation module 124 receives an image of the biometric parameter associated with a user (e.g., a fingerprint or retina scan). Upon receiving the image, pseudorandom metric generation module 200 reviews the image to identify properties of the image. Based on the properties, the module ascertains whether application of metrics would effectively define a set of important points in the image, and if so, what types and how many metrics should be applied to extract the maximum important points of the biometric parameter. If the properties exhibited in the image are insufficient to capture adequately the important points, metric generation module 200 may request a new image of the biometric parameter.

After this analysis, pseudorandom metric generation module 200 overlays one or more metrics on the image to define a set of important data points of the biometric parameter. Such metrics may include a set of lines, curves, circles, rectangles, squares, parallelograms, ellipses, parabolas, any other polygons, and so on. The important data points may be any number of items used to differentiate the parameters from one another. Examples of important data points might include crossings of the metrics on the biometric parameter, a quantity of important points such as minutiae encapsulated by the metrics, and so on.

FIG. 3 shows an exemplary fingerprint image 300 to illustrate how pseudorandom metrics are applied to the image to define important data points. Examples of metrics suitable for fingerprints include (1) the number of crossings and tangents a line or curve segment makes with the curves and whorls of the fingerprint, (2) the number of minutiae contained within a rectangular or circular region of the fingerprint, and (3) an area of the convex hull of minutiae contained within a given region. In this example, pseudorandom metric generation module 200 overlays metrics in the form of lines 302, 304, and 306 crossing the fingerprint image. Lines 302, 304, and 306 intersect with curves and whorls of the fingerprint to designate sets of intersecting points 302-A, 304-A, and 306-A, respectively.

Pseudorandom metric generation module 200 may be treated as a well known Radon transform to determine the metrics for application on the fingerprint. The Radon transform converts the image of the fingerprint from a two dimensional representation of I(x, y) into a matrix R (ρ, θ), where ‘ρ’ and ‘θ’ denote distances from origin and slopes of the lines, respectively. Metric generation module 200 may also employ a biometric transform to compute projections of the set of lines and utilize a small set of randomized line distances ‘ρ’ and angles ‘θ’ between lines 302, 304, and 306. The biometric transform further computes the number of crossings of the lines 302, 304, and 306 on the fingerprint image.

With reference again to FIG. 2, key generation module 202 may be invoked to produce secret keys that provide the randomness of the metrics. Each secret key may represent a metric and the attributes related to the metric. The attributes may be, for example, orientation, length, thickness, size, radius/or diameter, distances between each lines or curves or squares or any other polygons, and so on. As an alternative, a user-supplied password may be used as the secret key for providing the randomness among the metrics. The password can be fed directly to pseudorandom metric generation module 200 as a seed for the pseudorandom generation.

After the metrics are applied, pseudorandom metric generation module 200 counts the important points defined by each metric. As shown in FIG. 3, for example, pseudorandom generation module 200 counts the number of intersecting points 302-A, 304-A, and 306-A made by each line 302, 304, and 306 across the ridges and curves of fingerprint image 300. Here, there are six (6) intersecting points 302-A along line 302, eight (8) intersecting points 304-A along line 304, and twelve (12) intersecting points 306-A along line 306. It will be also understood that the numbers generated by pseudorandom generation module 200 may also denote a number of tangents, minutiae points and other important points developed by the lines 302, 304, and 306 with the fingerprint.

Vector computation module 204 (FIG. 2) defines vector representations of the applied metrics on the biometric parameter. In FIG. 3, the vectors for each point 302-A, 304-A, and 306-A exhibit the orientation of the ridges and curves of the fingerprint image 300. Vector computation module 204 combines or aggregates the vectors to form biometric hashes of the biometric parameters. In another implementation, the biometric hashes may be generated based on averages of the vectors.

Although three modules are shown in this implementation, it is noted that the functions conducted by these modules may be combined into fewer modules or separated into more modules.

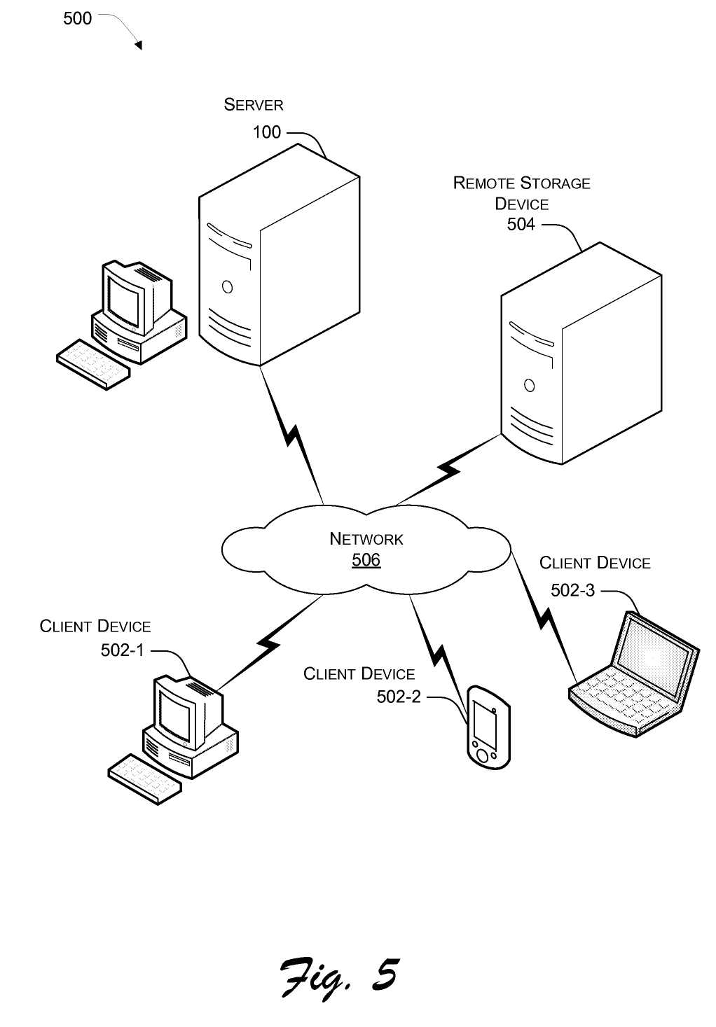

FIG. 4 shows an exemplary implementation of hash verification module 126 in more detail. Hash verification module 126 is invoked during an authentication session when a user is seeking to be authenticated. Module 126 includes a comparison module 400 and a threshold setting module 402.

Comparison module 400 retrieves input hashes 132 from temporary storage in program data 120 and examines the input hashes against stored hashes 130. More particularly, comparison module 400 attempts to discern whether the input hashes of the biometric parameter are identical to, or at least sufficiently similar to, the previously stored hashes. That is, hashes of two distinct biometric parameters should be distinct or dissimilar, whereas hashes of the same biometric parameter should be equal or very similar. In one implementation, comparison module 400 uses a similarity measure defined in terms of distances between vectors. Since the captured biometric parameters are subject to distortions, resulting hashes may be inexact and the distance-based similarity measure provides some flexibility in considering these distortions.

Threshold setting module 402 sets predefined thresholds against which a similarity measurement is compared. If the similarity exceeds the threshold, hash verification module 126 may authenticate a biometric parameter associated with the biometric hashes. In one embodiment, while the system is in a registration mode or another setting mode, the user can configure threshold setting module 402 to calculate and store a threshold value denoting an acceptable level of similarity between input hashes 132 and stored hashes 130. The threshold value may be calculated by reviewing and comparing biometric hashes generated from one or more images of the biometric parameter collected as stored hashes 130.

It is further noted that threshold setting module 402 may set multiple and varied threshold values based on various considerations, such as time, date, user, and so forth. For example, in the context of security access to an office building, different levels of security may be set depending on parameters like time of day, day of week, and grade of employees. In such a scenario, threshold setting module 402 may define a threshold value so that employees may be allowed to enter the office building more easily by setting a lower threshold value denoting a low degree of similarity between input hashes 132 and stored hashes 130. In another scenario, a lower threshold value may be set for higher grade employees while a higher threshold value is set for lower grade employees.

Additionally, in other implementations, a combination of multiple biometric hashes derived from different biometric parameters may be used. For instance, a user may be asked to enter two or more biometric parameters, such as different fingerprints, retina scan, and so forth. One set of biometric hashes may be produced from one biometric parameter (e.g., forefinger) and another set of biometric hashes may be generated from a second biometric parameter (e.g., thumb or retina scan). Both sets of hashes may then be compared to previously generated and stored hashes captured from the same parameters. Utilizing two or more sets of biometric hashes improves the level of assurance for authenticating the user.

In still other implementations, a combination of biometric hashes and other evaluation input data, such as a user password, may be used. That is, during authentication, the user might be requested to enter both a biometric parameter as well as his/her password. Combining biometric hashes together with passwords offers enhanced security, since authentication includes both “who you are” and “what you know” aspects. Optionally, as noted above, the password itself can serve as the secret key (or source of randomness) for generating the biometric hashes.

Although two modules are shown in this implementation, it is noted that the functions conducted by comparison module 400 and threshold setting module 402 may be combined into a single module, or separated into more modules.

Network Environment

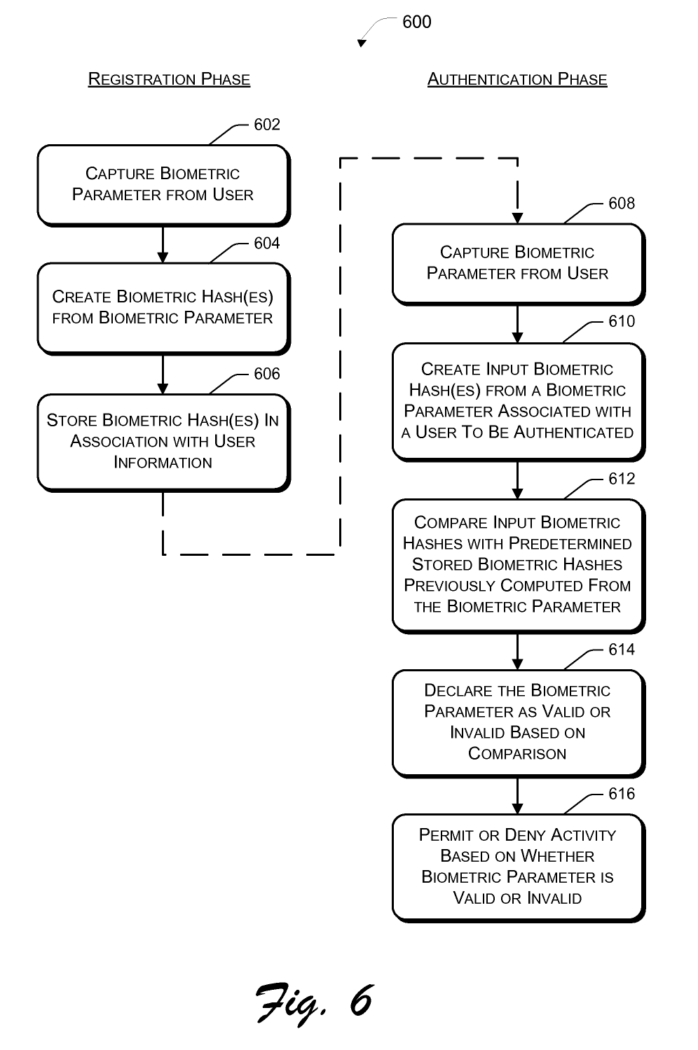

FIG. 5 illustrates an exemplary network architecture 500 in which biometric authentication may be implemented to facilitate client access to a server over a network. In this context, biometric hashes may be used to either augment or replace traditional passwords in such popular scenarios as system logons and Web-based authentication. In addition, biometric hashes can increase security whenever a person's physical identity needs to be confirmed, such as for passport issuance and verification, building security, purchase of restricted goods, and air travel. Assuming that a secret can be protected adequately on client devices (e.g., via smartcards), the one-way nature of biometric hashes may also help alleviate potential privacy issues.

Network architecture 500 includes server system 100 connected to client devices 502-1, 502-2, and 502-3 (collectively, devices 502) and remote storage device 504 over a network 506. Server 100 may be configured to receive one or more biometric hashes from client devices 502. Server 100 may be implemented, for example, as a general purpose computing device, multiple networked servers (arranged in clusters or as a server farm), a mainframe, and so forth.

Client devices 502 are equipped with biometric I/O devices to capture biometric parameters from respective users. Client devices 502 are representative of many different types of input devices, such as a general purpose computer, a server, a laptop, a mobile computing device, an entertainment device, a kiosk, an physical entry point device, and so on. Examples of network 506 include, but are not limited to, Local Area Network (LAN), Wide Area Network (WAN). Further, a network may be a wireless network, a wired network, or a combination thereof.

Each client device 502 may be configured to generate multiple input biometric hashes 132 from one or more captured biometric parameters. The input hashes are sent over network 506 to server 100, which maintains a file with a list of user IDs, their corresponding biometric hashes, access privileges, and any other suitable data. Server 100 compares the input hashes with stored hashes 130 in the file. If there is an exact match, server 100 declares input hashes 132 as valid and allows the client device to operate within the associated privileges permitted for that user and device. If the hashes are inexact, server 100 may analyze the input hashes based on a similarity measurement (e.g., minimum distance between vectors) instead of absolute equality. Thus, server 100 determines whether input hashes 132 are sufficiently similar to stored hashes 130 according to a predefined threshold set by an administrator. If sufficiently similar, server 100 declares input hashes 132 as valid and allows the client device to have the access privileges specified in the file.

Consider an example where a person wants to check a status of her booked air ticket through a centralized checking system that requires authentication of her biometric parameter, such as a fingerprint. To access these resources, client device 502 may initially send a request to server 100. Server 100 responds with a challenge requesting the user to scan his fingerprint. The user positions his finger on a biometric input device integrated into, or connected to, one of the client devices 502. A fingerprint image is captured and one or more biometric hashes (i.e. input hashes 132) are created therefrom by client device 502 based on the scanned fingerprint image and the challenge received from server 100. The hashes are returned to the server.

Server 100 compares the biometric hashes of the person's fingerprint with stored hashes of the fingerprint saved in the file to discern whether they match or are at least similar. If sufficiently similar, server 100 allows the person access to check the status of the ticket. If not, access is denied. In order to maintain an authenticated state as time elapses, the server may periodically issue further challenges to the client.

It is noted that the user may be asked to enter additional information for evaluation, such as a user password or hashes of other biometric parameters (e.g., different fingers, retina scan, patterns of blood vessels, etc.). In such cases, server 100 evaluates each piece of information submitted in response to the challenge and decides whether to authenticate the user based on the results.

In another implementation involving distributed devices, stored hashes 130 that have been previously captured may be saved in a file that is kept on remote storage device 504. Thus, server 100 may collect all or a subset of stored hashes 130 from this remote server and subsequently compare input hashes 132 with them to authenticate the fingerprint.

In another implementation, the evaluation may be performed on client devices 502. Upon request, server 100 provides stored hashes 130 to a client device over network 506, and the client device compares the newly captured biometric hashes (i.e. input hashes 132) with stored hashes 130. It is noted, in another implementation, the fingerprint image may be sent to server 100 from the client device, which then computes the hashes and makes the comparisons.

In another possible embodiment, client devices 502-1, 502-2, and 502-3 may receive and store one or more biometric parameters. Client devices 502 may then submit a request to server 100 to provide a set of secret keys related to the biometric hashes. The request contains identifiers (IDs) related to the user and thus associated with the biometric parameters of the user. The ID may be predefined by an administrator at server 100 during a setting mode. In response, server 100 uses the ID to locate one or more secret keys associated with the user. As described earlier, the secret keys may be used to establish a plurality of metrics to be applied to the biometric image (e.g., a fingerprint image). The secret keys may reside on server 100 or on remote storage device 504. Server 100 retrieves the secret keys and returns them to client devices 502-1, 502-2, and 502-3.

Upon receipt of the secret keys, client devices 502 generate and apply metrics to the biometric parameters to generate pseudorandom biometric hashes. Generation of random biometric hashes helps prevent replay attacks. The biometric hashes may be sent to sever 100 to be compared with stored hashes 130. If sufficiently similar, the user is authenticated. If not, the user is denied access.

Operation

Exemplary processes for creating biometric hashes from biometric parameters and authenticating the biometric parameters using the hashes are described with reference to FIGS. 1-5. These processes may be described in the general context of computer executable instructions. Generally, computer executable instructions can include routines, programs, objects, components, data structures, procedures, modules, functions, and the like that perform particular functions or implement particular abstract data types. The processes may also be practiced in a distributed computing environment where functions are performed by remote processing devices that are linked through a communications network. In a distributed computing environment, computer executable instructions may be located in both local and remote computer storage media, including memory storage devices.

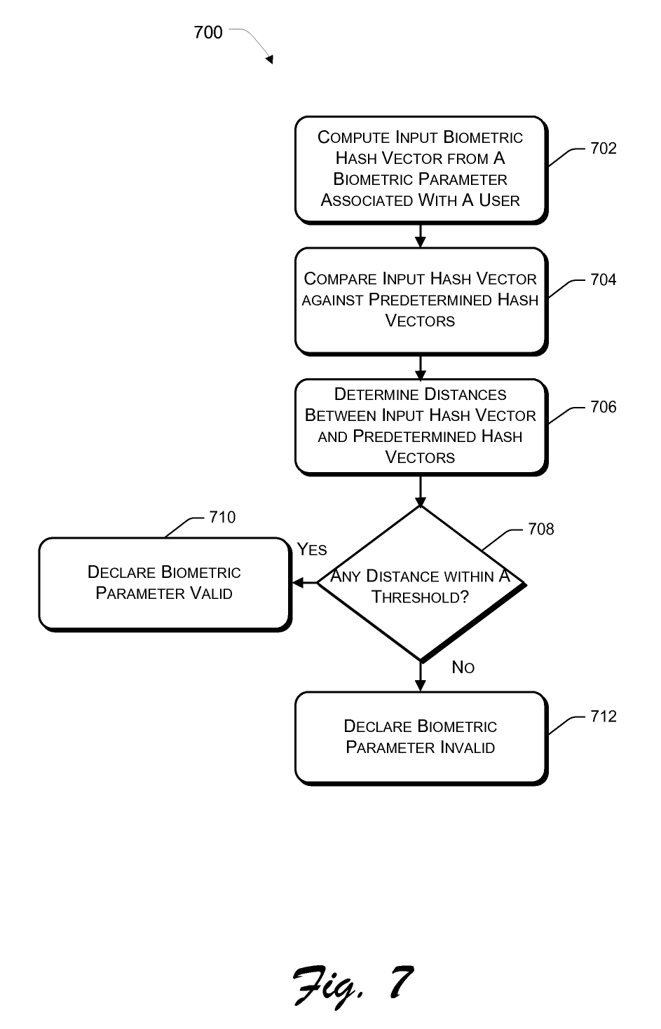

FIG. 6 illustrates an exemplary process 600 for creating hashes of biometric parameters during a registration phase and subsequently using the hashes to authenticate the biometric parameters of users during an authentication phase. Process 600 is illustrated as a collection of blocks in a logical flow graph, which represents a sequence of operations that can be implemented in hardware, software, or a combination thereof. The various operations are shown beneath headings to illustrate what functions are performed generally during the registration phase and the authentication phase. In the context of software, the blocks represent computer instructions that, when executed by one or more processors, perform the recited operations. The order in which the process is described is not intended to be construed as a limitation, and any number of the described blocks can be combined in any order to implement the process, or an alternate process. Additionally, individual blocks may be deleted from the process without departing from the spirit and scope of the subject matter described herein. For discussion purposes, process 600 is described with reference to the implementations of FIGS. 1-5.

At block 602, during a registration phase, a biometric parameter is captured from a user. The biometric parameter may be any type of parameter that uniquely identifies individual humans, with examples including a retina scan, a fingerprint, patterns of blood vessels in different areas of the body, and so on. The biometric parameter may be captured using biometric input/output devices 116. The biometric parameter can be stored electronically in a local server 100 or in a remote storage device 504 accessible over a network 506. It is further noted that more than one biometric parameter may be captured. For instance, during registration, a user may submit fingerprints from different fingers, a retina scan, and/or multiple different blood vessel patterns.

At block 604, one or more biometric hashes are created from each biometric parameter. There are many ways to create such hashes. Generally, the biometric hashes can be generated by applying one or more metrics to the biometric parameter and evaluating those metrics on the biometric parameter. For example, in the case of fingerprints, geometric shapes (e.g., lines, curves, circles, rectangles, squares, parallelograms, ellipses, parabolas, any other polygons) are overlaid onto a fingerprint image and the number of intersections of those metrics with fingerprint ridges and curves are used to define vectors that uniquely identify the fingerprint. One particular example is described above with reference to FIG. 3. This operation may be performed, for example, by hash generation module 124.

At block 606, the biometric hashes are stored in association with user information, such as user IDs, user profile, biometric parameter type (e.g., fingerprint ID, retina scan, etc.) and access rights. The biometric hashes may be stored locally in server 100 or remotely in a remote storage device 504. The stored biometric hashes thereby form a database of known user data against which biometric parameters captured in the future may be authenticated.

At block 608, during a subsequent authentication phase, the biometric parameter of the user is captured anew. The biometric parameter may be captured using the same I/O devices used during registration or different devices.

At block 610, one or more input hashes are created from the newly captured biometric parameter. These hashes may be computed using the same techniques that were employed during registration, as described above.

At block 612, the input biometric hashes are compared with the predetermined biometric hashes that were previously computed during registration. Ideally, the input hashes would identically match one or more of the stored hashes. However, since capturing biometric parameters may introduce distortions (e.g., scanner-dependent artifacts, orientation issues, breakage or clarity of image, etc.) the resulting biometric hashes may be inexact. For determining whether two hashes originated from the same biometric parameter, process 600 may utilize a measure of distance between the hashes (e.g., Euclidean distance). In addition, hash robustness may be enhanced by performing aggregation or error correction on the vector of metrics. Additionally, in some cases, the input hashes may be compared with multiple sets of stored hashes taken from a variety of orientations or a variety of different input conditions of the same biometric parameter, thereby producing a larger sample set. Furthermore, multiple biometric sources may be used simultaneously to authenticate the user. One exemplary process is described below with reference to FIG. 8.

In one example, the comparison is performed by comparison module 400 of hash verification module 126. Threshold setting module 402 sets a threshold value that expresses a level of similarity between the hashes that is deemed satisfactory for authenticating the user. Different thresholds may be set for different individual users, or different classes of users, or types of authentication (e.g., building access, computer access, remote server access, etc.), or any other suitable factor.

At block 614, the biometric parameter is declared valid or invalid based on the comparison. If one or more of the input hashes are identical or sufficiently similar to the predetermined hashes, the biometric parameter is deemed valid as belonging to the same user. Validation may be predicated upon a single hash meeting the preset threshold, or upon multiple hashes meeting the threshold. Conversely, if none of the input hashes is sufficiently similar to the predetermined hashes, the biometric parameter is deemed invalid.

At block 616, the activity being sought by the user is either permitted or denied based upon whether the biometric parameter is declared valid or invalid. The activity may be any activity for which user authentication is being sought, including physical access, log on access, access to remote computer resources, and the like.

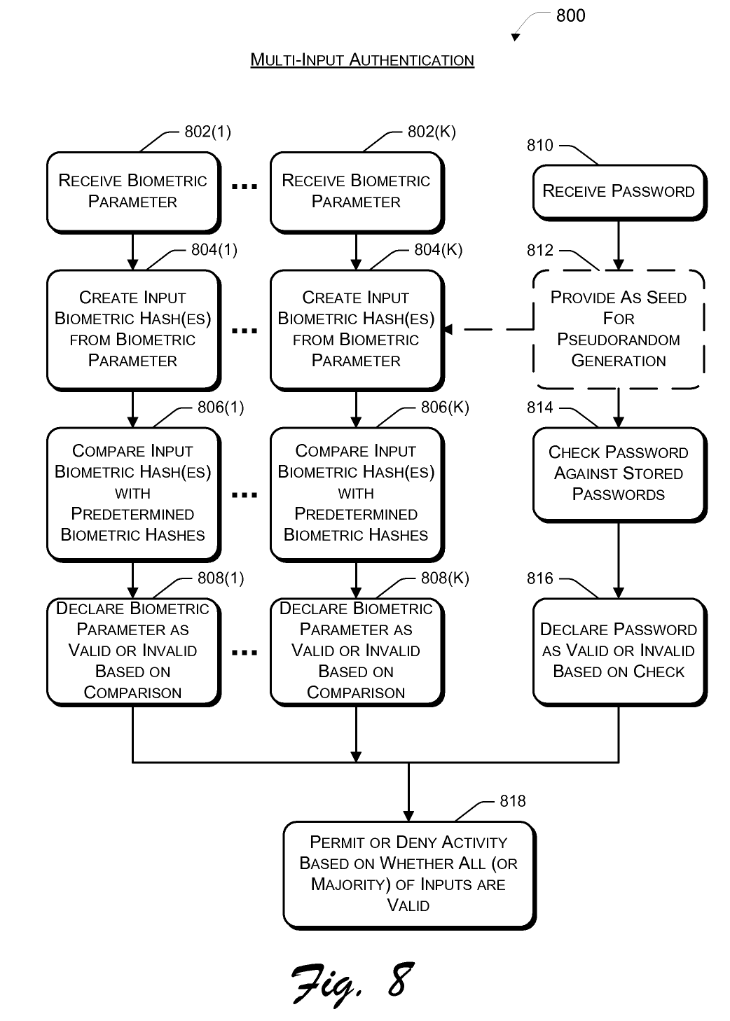

FIG. 7 illustrates a more detailed process 700 for analyzing input biometric hashes against the predetermined biometric hashes during authentication. Generally, the analysis techniques should exhibit characteristics that the hashes of two distinct biometric parameters should be distinct or dissimilar, while hashes of the same biometric parameter should be equal or similar. In this example, process 700 employs distance between vectors as a measure of similarity, and hence determines whether distances between the input biometric hash vectors and predetermined biometric hash vectors satisfy a threshold distance.

For discussion purposes, process 700 is described in the exemplary context of authenticating a biometric image (e.g., fingerprint image) captured from a user. Thus, prior to block 702, a biometric image has been captured and processed to produce a two-tone image.

At block 702, a biometric hash in the form of a vector is computed from a biometric parameter associated with a user who is seeking authentication. The biometric hash is generated by determining a hash vector of the biometric parameter. In one example, cryptographic pseudorandom metric generation module 200 embeds a plurality of metrics on the biometric parameter. As an example, pseudorandom metric generation module 200 chooses N line segments s₁ , s₂ , . . . , s_{N} that cross the biometric image. For each segment sᵢ, a count cᵢ of crossings and tangents with shapes in the biometric image is computed. Pseudorandom metric generation module 200 outputs a hash vector Vᵢₙₚᵤₜ of these counts, such that Vᵢₙₚᵤₜ=(c₁ , c2 , . . . , C_{N}). It is noted that, although line segments are described, many variants are possible, such as squares, polygons, ellipses, parabolas, and other shapes. The precise choice of metrics may depend on the characteristics of biometric parameters and the scanners.

At block 704, the input biometric hash vector Vᵢₙₚᵤₜ=(c₁ , c₂ , . . . , c_{N}) is compared to multiple predetermined biometric hash vectors that were previously derived from the same biometric parameter of the user. These predetermined biometric hash vectors were previously captured and stored during registration. For example, one of the predetermined hash vectors may be denoted as V_{stored}=(Cⱼ, cₖ , . . . , C_{N}). Input hash vector Vᵢₙₚᵤₜ=(c₁, c₂, . . . , C_{N}) is compared to one or more stored vectors, such as V_{stored}=(cⱼ, cₖ, . . . , c_{N}).

At block 706, distances between the biometric hash vector and the predetermined biometric hash vectors are computed. For example, hash verification module 126 may evaluate Euclidean distances between the input hash vectors Vᵢₙₚᵤₜ=(c₁, c₂ , . . . , c_{N}) and predetermined biometric hashes, Vᵢₙₚᵤₜ=(cⱼ, cₖ , . . . , C_{N}). In another implementation, hash verification module 126 may evaluate the distances between a hash vector V=(c₁, C₂ , . . . , c_{N}) determined from an average of the hash vectors of the biometric hash and hash vectors of the predetermined biometric hashes; for example, V=(cⱼ, cₖ , . . . , c_{N}). In such an implementation, calculation of the average of the hash vectors can enable the hash verification module to be robust by adjusting for errors that may occur while computing the distances and the errors that may have occurred while generating the hash vectors.

In yet another implementation, hash verification module 126 may be configured to determine distances between a primary hash vector determined from an average of the hash vectors of the biometric hash and a secondary hash vector determined from an average of the hash vectors of the predetermined biometric hashes. In another exemplary implementation, distances between each hash vectors forming the biometric hash and a hash vector computed from an average of the hash vectors of the predetermined biometric hashes is evaluated by hash verification module 126.

At block 708, a determination is made whether any of the distances is within a threshold predefined by the user in the system. If any of the distances between the biometric hash and the predetermined biometric hashes is within a threshold, (i.e., “yes” path from block 708), the biometric parameter is declared valid by the system (block 710). If any of the distances between the biometric hash and the predetermined biometric hashes is not within a threshold (i.e., “no” path from block 708), the biometric parameter is declared invalid and the user device is denied access to the system (block 712).

FIG. 8 illustrates an exemplary process 800 for using hashes of multiple biometric parameters, along with a user-supplied password, to authenticate a user during the authentication phase. In this multi-input authentication process, the user has previously registered different and multiple biometric parameters along with a user password during a registration phase. Accordingly, process 800 illustrates the operations that occur during authentication.

As illustrated, process 800 involves entry of multiple biometric parameters, entry of a user password, and/or entry of a combination of a password and one or more biometric parameters. Blocks 802-808 pertain to entry of different biometric parameters, whereas blocks 810-816 pertain to entry of one or more user passwords. Higher levels of assurance can be achieved by evaluating multiple inputs. Additionally, by evaluating a password in combination with one or more biometric parameters, the process offers enhanced assurance that the person seeking authorization is indeed the known user as the dual inputs answer both “who you are” (i.e., biometric parameters) and “what you know” (i.e., password).

At blocks 802(1)-802(K), multiple different biometric parameters of the user are captured. For example, the user may be invited to scan multiple fingerprints, and/or one or both retinas, and/or have various patterns of blood vessels recorded.

At blocks 804(1)-804(K), one or more input hashes are respectively created from each newly captured biometric parameter. The hashes may be computed using the same techniques described above.

At blocks 806(1)-806(K), the input biometric hashes are compared with the predetermined biometric hashes that were previously computed during registration. Ideally, the input hashes would identically match one or more of the stored hashes. However, since capturing biometric parameters may introduce distortions (e.g., scanner-dependent artifacts, orientation issues, breakage or clarity of image, etc.) the resulting biometric hashes may be inexact. Thus, process 800 may utilize a measure of similarity, such as the distance calculations described above.

At blocks 808(1)-808(K), the biometric parameters are declared valid or invalid based on the comparisons. If the input hashes are identical or sufficiently similar to the predetermined hashes, the biometric parameter is deemed valid as belonging to the same user. Validation may be predicated upon a single hash meeting the preset threshold, or upon multiple hashes meeting the threshold. Conversely, if none of the input hashes is sufficiently similar to the predetermined hashes, the biometric parameter is deemed invalid.

As represented by blocks 810-816, the user may be asked to supply one or more passwords as a part of the authentication process. At block 810, a password entered by the user is received. The password may be an alphanumeric code, or a numeric-only code, or any other form of entered code.

At block 812, the password can be optionally used as a secret key or seed for hash generation. In this manner, the password provides a source of randomness when applying metrics to the captured parameters.

At block 814, the password is compared to other passwords in a general repository, or to passwords that are associated with the user having the biometric parameters under evaluation. At block 816, the password is declared valid or invalid based on whether a match is found.

At block 818, the activity being sought by the user is either permitted or denied based upon whether all, or a majority, of inputs are valid.

Conclusion

Although embodiments of techniques for authenticating biometric parameters via biometric hashing have been described in language specific to structural features and/or methods, it is to be understood that the subject of the appended claims is not necessarily limited to the specific features or methods described. Rather, the specific features and methods are disclosed as exemplary implementations.

What is claimed is:

1. A method comprising:
receiving a password;
receiving a biometric parameter;
creating at least one biometric hash from the biometric parameter; and
authenticating a user based on evaluation of a combination of the biometric hash and the password.

2. The method as recited in claim 1, wherein the creating at least one biometric hash comprises generating the biometric hash using pseudorandom generation, wherein the password serves as a seed for the pseudorandom generation.

3. The method as recited in claim 1, wherein the creating comprises:
applying a plurality of metrics to the biometric parameter, wherein the metrics exhibit pseudorandomness; and
generating, from the metrics, one or more hash vectors that represent the biometric hashes.

4. The method as recited in claim 3, further comprising extracting the biometric hashes from an aggregate of the hash vectors.

5. The method as recited in claim 1, wherein the authenticating comprises determining whether the biometric hash matches at least one predetermined biometric hash.

6. The method as recited in claim 1, wherein the authenticating comprises determining a measure of similarity between the biometric hash and at least one predetermined biometric hash.

7. The method as recited in claim 6, wherein the measure of similarity is a function of distances between one or more vectors representing the biometric hash and one or more vectors representing the predetermined biometric hash.

8. A method comprising:
receiving a first biometric parameter captured from a user;
receiving a second biometric parameter captured from the user, wherein the second biometric parameter is different than the first biometric parameter;
creating biometric hashes from the first and second biometric parameters; and
authenticating the user based on evaluation of the biometric hashes from both the first and second biometric parameters.

9. The method as recited in claim 8, wherein the first biometric parameter is a fingerprint image and the second biometric parameter is selected from a group of parameters comprising another fingerprint image, a retina scan, and a blood vessel pattern.

10. The method as recited in claim 8, further comprising receiving a password and authenticating the user based on evaluation of the biometric hashes and the password.

11. The method as recited in claim 10, wherein the creating biometric hashes comprises:
applying metrics to the first and second biometric parameters, wherein the metrics exhibit pseudorandomness; and
generating, from the metrics, hash vectors that represent the biometric hashes.

12. The method as recited in claim 11, wherein the pseudorandomness is achieved using pseudorandom generation based on a secret key, and the password serves as the secret key.

13. The method as recited in claim 8, wherein the authenticating comprises determining whether the biometric hashes match predetermined biometric hashes.

14. The method as recited in claim 8, wherein the authenticating comprises determining measures of similarity between the biometric hashes and predetermined biometric hashes.

15. The method as recited in claim 14, wherein each measure of similarity is a function of distances between one or more vectors representing a biometric hash and one or more vectors representing a predetermined biometric hash.

16. One or more computer-readable media comprising computer executable instructions that, when executed, perform acts comprising:
generating at least one biometric hash based on a biometric parameter captured from a user; and
authenticating the user based on evaluation of a combination of at least the biometric hash and a second evaluation input, the second evaluation input being at least one of (1) at least one biometric hash of another biometric parameter or (2) a password.

17. The one or more computer-readable media as recited in claim 16, wherein the biometric parameters are selected from a group of parameters comprising a plurality of different fingerprint images, retina scans, and blood vessel patterns.

18. The one or more computer-readable media as recited in claim 16, wherein the generating at least one biometric hash comprises generating the biometric hash using pseudorandom generation, wherein the password serves as a seed for the pseudorandom generation.

19. The one or more computer-readable media as recited in claim 16, wherein the authenticating comprises determining whether the biometric hash matches at least one predetermined biometric hash.

20. The one or more computer-readable media as recited in claim 16, wherein the authenticating comprises determining a measure of similarity between the biometric hash and at least one predetermined biometric hash.
